(19) United States
(12) Patent Application Publication
(10) Pub. No.: US 2020/0232570 A1
(43) Pub. Date: Jul. 23, 2020

(54) VALVE

(71) Applicants: Jason Edwards, Broken Arrow, OK (US); Grant R. Thompson, Tulsa, OK (US); John Burris, Bixby, OK (US); Rion Rogers, Houston, TX (US)

(72) Inventors: Jason Edwards, Broken Arrow, OK (US); Grant R. Thompson, Tulsa, OK (US); John Burris, Bixby, OK (US); Rion Rogers, Houston, TX (US)

(73) Assignee: Baker Hughes, a GE company, LLC, Houston, TX (US)

(21) Appl. No.: 16/250,917

(22) Filed: Jan. 17, 2019

(51) Int. Cl. F16K 15/03; F16K 17/04

(52) U.S. Cl. CPC F16K 15/035; F16K 15/033; F16K 17/0493

(57) ABSTRACT

A valve including a closure member having a first portion and a second portion the first and second portions in fluid tight contact with one another when closed and spaced when open, a flow tube in operative contact with the closure member.

### BACKGROUND

In the resource recovery industry it is common to use valves for control of fluids moving into or out of a well. One type of ubiquitous valve is a safety valve such as a surface controlled subsurface safety valve. Safety valves generally include a flapper, a flow tube longitudinally shiftable to open the flapper and a power spring that is compressed when the valve is open and will cause the valve's closure if the impetus to remain open (often a hydraulic line pressure on a piston in operable communication with the flow tube) is lost for some reason. Safety valves work well for their purpose but fiscal issues leaving companies in constant need of efficiencies that can reduce cost, weight, etc. and or increase longevity. Hence the art will well receive new configurations that provide benefits.

### SUMMARY

A valve including a closure member having a first portion and a second portion the first and second portions in fluid tight contact with one another when closed and spaced when open; a flow tube in operative contact with the closure member.

### BRIEF DESCRIPTION OF THE DRAWINGS

The following descriptions should not be considered limiting in any way. With reference to the accompanying drawings, like elements are numbered alike:

FIG. 1 is a cross sectional view of a valve as disclosed herein in a closed position;

FIG. 2 is the valve illustrated in FIG. 1 but with the valve housing transparent and in a partially open position;

FIG. 3 is a perspective view of the valve in the position illustrated in FIG. 2;

FIG. 4 is the valve in the open position;

FIG. 5 is a perspective view of the flow tube of the valve apart from other components of the valve; and

FIG. 6 is a schematic view of a wellbore system having the valve as shows in FIG. 1.

### DETAILED DESCRIPTION

A detailed description of one or more embodiments of the disclosed apparatus and method are presented herein by way of exemplification and not limitation with reference to the Figures.

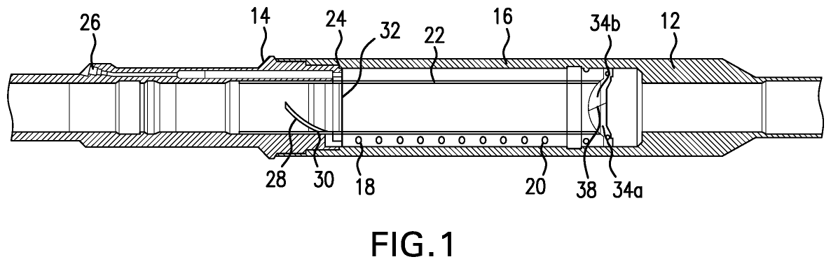

Referring to FIG. 1, a valve 10 is illustrated in a closed position. The valve 10 is generally employed in a hydrocarbon well and may be configured as a safety valve as that term is used in the vernacular. The valve 10 includes a spring housing 12 and a piston housing 14 connected together to house components of the valve 10. Disposed within the spring housing 12 is a torsion spring 16 connected at one end 20 to the spring housing 12 and at its other end 18 to a flow tube 22 disposed within the housing. The flow tube is actuable both longitudinally and rotationally by a piston 24 connected to a hydraulic pressure supply 26, which may be connected to a control line (not shown) or any source of pressure. The piston 24 provides for the longitudinal motion directly while a force generated by the piston is indirectly responsible for the rotational motion of the flow tube 22 due to a cam slot 28 in the flow tube 22 that interacts with a pin 30 fixed to the piston housing 14. The flow tube 22 includes a drive member 32 interactive with the piston 24. It will be noted that the piston could also be an annular piston arrangement and retain function as described herein.

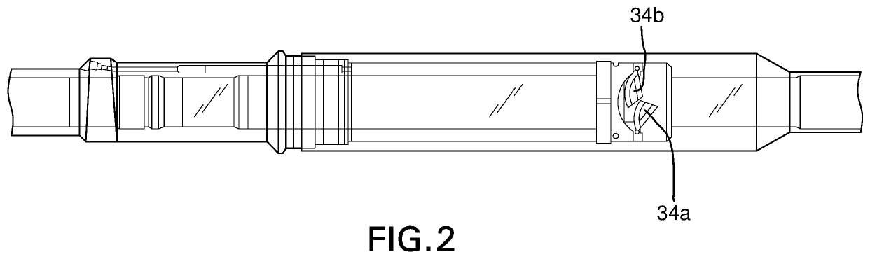

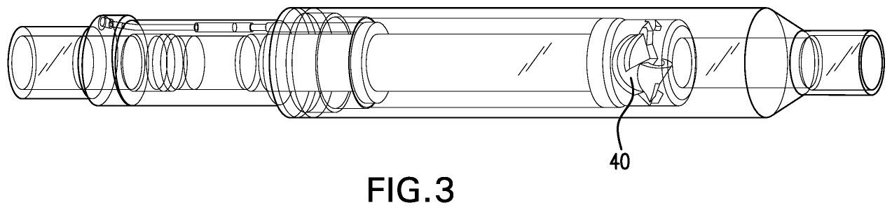

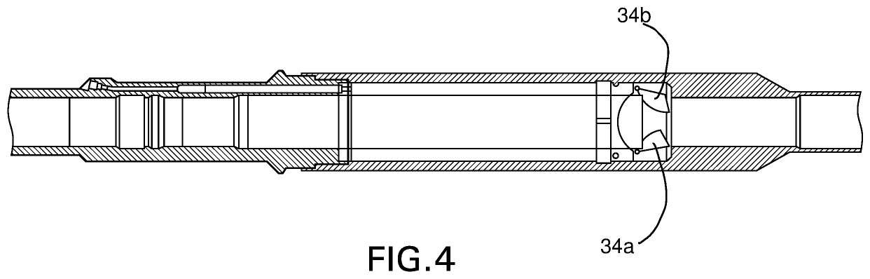

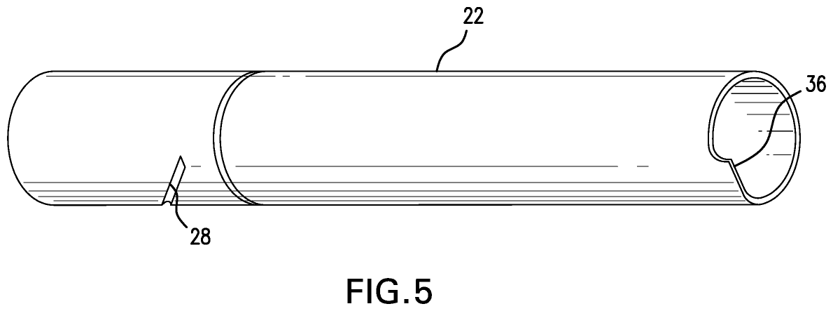

At a downhole end of the flow tube 22 a multi portion closure member 34 such as a flapper having portions 34a and 34b is interactive with the flow tube 22. In an embodiment, the flow tube 22 includes a profile 36 (best visible in FIG. 5) to ensure flapper 34 portions 34a and 34b open at staggered start times. Referring directly to the flapper 34 and back to FIG. 1, the multiple portions 34a and 34b meet in the closed position at a seal line 38. It will be appreciated that the seal line 38 is not aligned with the longitudinal axis of the valve 10 but is rather at an angle thereto. The angle is from about 5 degrees to about 60 degrees. In an embodiment, the angle is about 29 degrees. This is to ensure proper closure of the flapper 34. Ancillary to this angle however is the desirability of opening portion 34a slightly in advance of 34b. This can be seen in FIGS. 2 and 3 where the valve 10 in a position of partial opening of the valve 10. It will be recognized that portion 34a is more displaced from the closed position illustrated in FIG. 1 than is portion 34b. In an embodiment, this advance beginning of the opening movement of portion 34a is occasioned by the interaction of the profile 36 on the flow tube 22 with the portion 34a. More specifically, rotation of flow tube 22 will align profile 36 with portion 34a thereby forcing that portion 34a off the seat 40 (best visible in FIG. 3). Further rotation of the flow tube 22 along with axial motion dictated by cam slot 28 will continue to force portion 34a to a fully open position as well as forcing portion 34b off the seat 40 and to a fully open position. The fully opening position of valve 10 is illustrated in FIG. 4. It is to be understood that the degree to which rotation and the degree to which longitudinal displacement of the portions 34a and 34b caused opening of the valve 10 can be adjusted based upon the angle of the cam slot 28.

All of the motion rotationally and longitudinally is predicated upon a pressure up scenario at the source 26. And if pressure is lost at the source, whether because that pressure was intentionally removed or if a malfunction caused that pressure to be lost, the valve 10 will automatically immediately close. The valve 10 is assisted in this operation by the torsion spring 16 introduced above. The spring looks similar in the Figures to a compression spring of the prior art but it is not so configured. Rather the spring 16 is intentionally configured as a torsion spring. A torsion spring is loaded in bending and accordingly is able to use up to 90 percent of its tensile strength. A compression spring is loaded in shear and hence can only use about 55 percent of its ultimate tensile strength. The result of employing a torsion spring instead of a compression spring is that the material can be significantly lighter and more cost effective. Sizing a material for a job that can use 90 percent of its strength versus sizing a material for the same job where due to configuration the material can only use 55 percent of its strength. The material would have to be almost double in size, weight, and cost to be used in shear rather than in bending. The valve 10 as described herein by employing a torsion spring 16 benefits in size and cost. Additionally the valve can achieve the full open position with about ⅓ the linear movement (based on angle 28 in flow tube 22). The reduced linear movement means the piston housing 14, spring housing 12, and flow tube 22 can also be reduced in length saving additional size and cost of supporting material.

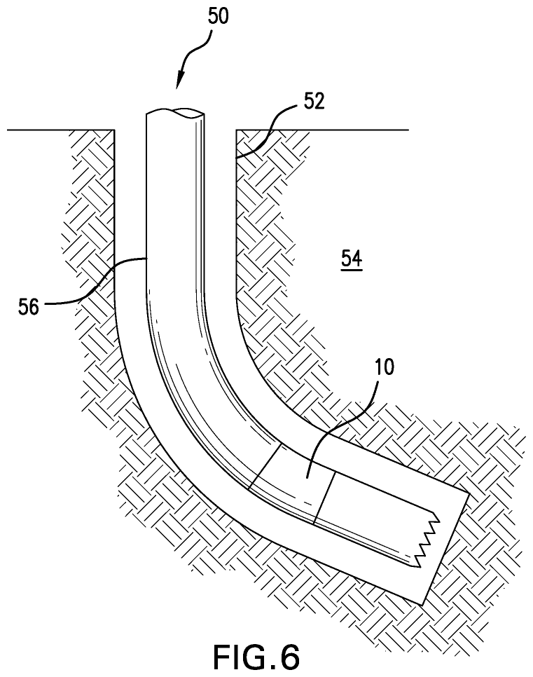

In an embodiment, the valve 10 as described herein is a part of a wellbore system 50 including a borehole 52 into a subsurface formation 54 having a tubing string 56 therein. This is schematically illustrated in FIG. 6. Such a system 50 enjoys a greater profitability to cost ratio than prior art systems.

Set forth below are some embodiments of the foregoing disclosure:

### Embodiment 1

Embodiment 1: A valve including a closure member cooperative with a seat, the closure member having a first portion and a second portion the first and second portions in fluid tight contact with one another when closed and spaced when open; a flow tube in operative contact with the closure member.

### Embodiment 2

The valve as in any prior embodiment wherein the first portion and second portion are of similar but not identical shape.

### Embodiment 3

The valve as in any prior embodiment wherein the first and second portions meet to create the fluid tight contact at an intersection line that is angled relative to a longitudinal axis of the flow tube.

### Embodiment 4

The valve as in any prior embodiment wherein the angle is about 5 degrees to about 60 degrees from the valve centerline.

### Embodiment 5

The valve as in any prior embodiment wherein the flow tube includes a profile configured to initiate movement of one of the first and second portions before the other of the first and second portions.

### Embodiment 6

The valve as in any prior embodiment wherein the profile is a longer portion of the flow tube.

### Embodiment 7

The valve as in any prior embodiment wherein the flow tube is actuatable longitudinally.

### Embodiment 8

The valve as in any prior embodiment wherein the flow tube is actuatable rotationally.

### Embodiment 9

The valve as in any prior embodiment wherein the flow tube is actuatable both longitudinally and rotationally.

### Embodiment 10

The valve as in any prior embodiment wherein the flow tube includes a cam slot.

### Embodiment 11

The valve as in any prior embodiment wherein the cam slot causes simultaneous rotational and longitudinal movement of the flow tube during use.

### Embodiment 12

The valve as in any prior embodiment further comprising a torsion spring configured and positioned to torsionally act on the flow tube.

### Embodiment 13

A method for actuating a valve including causing the flow tube of the valve as in any prior embodiment move; and opening the closure member.

### Embodiment 14

The method as in any prior embodiment wherein the causing is delivering pressure from a source of pressure to the valve.

### Embodiment 15

The method as in any prior embodiment wherein causing the flow tube to move includes imparting longitudinal movement to the flow tube.

### Embodiment 16

The method as in any prior embodiment wherein causing the flow tube to move includes imparting rotational movement to the flow tube.

### Embodiment 17

The method as in any prior embodiment wherein causing the flow tube to move includes imparting both longitudinal and rotational movement to the flow tube.

### Embodiment 18

The method as in any prior embodiment wherein one of the first and second portions is contacted by the flow tube before the other of the first and second portion and begins opening first.

The terms “about” and “substantially” are intended to include the degree of error associated with measurement of the particular quantity based upon the equipment available at the time of filing the application. For example, “about” and/or “substantially” can include a range of ±8% or 5%, or 2% of a given value.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

The teachings of the present disclosure may be used in a variety of well operations. These operations may involve using one or more treatment agents to treat a formation, the fluids resident in a formation, a wellbore, and/or equipment in the wellbore, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A valve comprising:
a closure member cooperative with a seat, the closure member having a first portion and a second portion the first and second portions in fluid tight contact with one another when closed and spaced when open;
a flow tube in operative contact with the closure member.

2. The valve as claimed in claim 1 wherein the first portion and second portion are of similar but not identical shape.

3. The valve as claimed in claim 1 wherein the first and second portions meet to create the fluid tight contact at an intersection line that is angled relative to a longitudinal axis of the flow tube.

4. The valve as claimed in claim 3 wherein the angle is about 5 degrees to about 60 degrees from the valve centerline.

5. The valve as claimed in claim 1 wherein the flow tube includes a profile configured to initiate movement of one of the first and second portions before the other of the first and second portions.

6. The valve as claimed in claim 5 wherein the profile is a longer portion of the flow tube.

7. The valve as claimed in claim 1 wherein the flow tube is actuatable longitudinally.

8. The valve as claimed in claim 1 wherein the flow tube is actuatable rotationally.

9. The valve as claimed in claim 1 wherein the flow tube is actuatable both longitudinally and rotationally.

10. The valve as claimed in claim 1 wherein the flow tube includes a cam slot.

11. The valve as claimed in claim 10 wherein the cam slot causes simultaneous rotational and longitudinal movement of the flow tube during use.

12. The valve as claimed in claim 1 further comprising a torsion spring configured and positioned to torsionally act on the flow tube.

13. A method for actuating a valve comprising:
causing the flow tube of the valve as claimed in claim 1 to move; and
opening the closure member.

14. The method as claimed in claim 13 wherein the causing is delivering pressure from a source of pressure to the valve.

15. The method as claimed in claim 13 wherein causing the flow tube to move includes imparting longitudinal movement to the flow tube.

16. The method as claimed in claim 13 wherein causing the flow tube to move includes imparting rotational movement to the flow tube.

17. The method as claimed in claim 13 wherein causing the flow tube to move includes imparting both longitudinal and rotational movement to the flow tube.

18. The method as claimed in claim 13 wherein one of the first and second portions is contacted by the flow tube before the other of the first and second portion and begins opening first.
